(19) United States
(12) Patent Application Publication
(10) Pub. No.: US 2014/0111326 A1
(43) Pub. Date: Apr. 24, 2014

(54) METHOD AND APPARATUS FOR WIRELESS MONITORING OF TIRE CONDITIONS

(71) Applicant: Vladimir Borisenko, Surrey (CA)

(72) Inventor: Vladimir Borisenko, Surrey (CA)

(73) Assignee: SST Wireless Inc., Delta, BC (CA)

(21) Appl. No.: 14/122,350

(22) PCT Filed: Jun. 6, 2012
(86) PCT No.: PCT/CA2012/000545

§ 371 Date: Nov. 26, 2013

Related U.S. Application Data
(60) Provisional application No. 61/457,798, filed on Jun. 6, 2011.

(51) Int. Cl. B60C 23/02; H04W 4/00

(52) U.S. Cl. CPC B60C 23/02; H04W 4/006
USPC 340/447

(57) ABSTRACT

A method and system to monitor tire conditions in a vehicle when the vehicle is traveling in and out of RF coverage zones provided by one or more remote monitoring stations uses one or more sensor assemblies on the vehicle to sense conditions such as pressure or temperature. When the vehicle is not within the RF coverage zone of a remote monitoring station, sensor data generated at the sensor assemblies is stored on a communication module mounted on the vehicle. The sensed data is sent to the remote monitoring station once the vehicle enters the RF coverage zone. Regardless of whether the vehicle is in an RF coverage zone, the driver of the vehicle can still monitor tire conditions via a display in the vehicle that shows tire conditions. Two-way communication between the remote monitoring station and the sensor assemblies allows remote adjustment of operation of the sensor assemblies.

This application claims priority from U.S. Provisional Patent Application Ser. No. 61/457,798, filed 6 Jun. 2011, under 35 U.S.C. §119(e), which is incorporated in its entirety by reference herein.

### FIELD OF THE INVENTION

The invention relates to a method and apparatus for wireless monitoring of tire conditions, including, for example, conditions such as tire pressure and/or temperature. The method and apparatus can be used to provide real-time monitoring of tire condition while the vehicle is in use.

### BACKGROUND ART

Existing systems provide wireless monitoring of vehicle tires on multi-tire vehicles such as articulated trucks. Sensor assemblies typically comprise an antenna that transmits status information to a monitoring unit on the vehicle. A display unit can be used to indicate the status or condition of tires. Examples of these systems can be found in United States Published Patent Application No. 2011/0043354 to Shepler et al, U.S. Pat. No. 5,963,128 to McClelland et al., and U.S. Pat. No. 6,945,103 to Lee et al.

Existing systems may not be suitable in circumstances when there is a requirement for a remote monitoring station to maintain information about the vehicle's status and where the vehicle is only intermittently within range of the remote monitoring station. In these circumstances, it is also important for a driver or operator of the vehicle to be aware of the tire status or condition, and to receive alerts when irregular conditions occur. Existing display systems can also lead to driver distraction. Thus, there is a need to improve the visual and audible information supplied to the driver in a way that reduces distraction, and makes diagnosis and monitoring a simple activity.

In some vehicles such as low-floor, articulated buses, it can be difficult to achieve the required sensitivity, at the monitoring unit on the vehicle, to signals transmitted by sensor assemblies located on the wheels or tires. Therefore, there is also a need to have a configuration of transceivers on the vehicle that provide higher sensitivity than might be achieved by having more than one antenna and only one transceiver.

Existing systems provide limited data transfer and offloading capabilities. There is also a need for on-vehicle monitoring units to have a wide variety of data transfer and offloading options.

Sensor assemblies in existing systems act as transponders. These systems have limited accuracy and flexibility. For example, it is desirable to be able to calibrate sensor assemblies during manufacture for greater accuracy, and to have the flexibility to change the parameters defining sensor operation while the vehicle and the wireless monitoring system is in use.

### SUMMARY OF THE INVENTION

A method for wirelessly monitoring tire conditions on a vehicle comprises sensing a tire condition, for example, using one or more sensor assemblies on the vehicle; wirelessly transmitting sensed data related to the tire condition to at least one communication module mounted on the vehicle; and sending a signal from the communication module to a display unit mounted on the vehicle so that an operator can monitor tire conditions in real time. During time periods when the vehicle is not within an RF coverage zone provided by one or more remote monitoring stations, the sensed data related to the tire condition is stored in non-volatile memory in the communication module. When the vehicle moves into an RF coverage zone of a remote monitoring station, real-time sensed data related to the tire condition and stored data from the non-volatile memory is wirelessly transmitted, via an RF modem, to the remote monitoring station. For example, historical data related to the tire condition that was stored in the non-volatile memory when the vehicle was not within an RF coverage zone is transmitted to the remote monitoring station when the vehicle moves into an RE coverage zone. When the vehicle is within an RF coverage zone, real-time sensed data is wirelessly transmitted to the remote monitoring station, and is optionally also stored in the non-volatile memory in the communication module.

In some embodiments of the method, the real-time sensed data continues to be transmitted by the communication module, via the RF modem, even when the vehicle is not within any of the RF coverage zones provided by the one or more remote monitoring stations.

In some embodiments of the method, there is two-way communication between the one or more remote monitoring stations and the sensor assemblies via the communication module when the vehicle is within an RF coverage zone provided by the one or more remote monitoring stations. For example, the method can further comprise transmitting parameters to the sensor assemblies from the at least one remote monitoring station, via the communication module and a transceiver in the sensor assembly, for calibration of sensors in the sensor assemblies or for updating parameters in the sensor assembly to adjust operation of the sensor assembly.

A method for generating calibrated sensor data from a sensor assembly, used in a system for wirelessly monitoring tire conditions on a vehicle, comprises activating the sensor assembly and causing the sensor assembly to enter a calibration mode. For the purposes of calibration, measurement data is transmitted from the sensor assembly to a receiver while the sensor assembly is maintained at a known steady temperature and pressure. Transmission of measurement data from the sensor assembly is repeated at four or more temperature and pressure measurement points, and calibration coefficients of a function are generated that describe the relationship between the measurement data and the known temperature and pressure measurement points. The calibration coefficients are then downloaded to the sensor assembly. Next, the sensor assembly exits the calibration mode and enters a working mode in which the sensor assembly can be used for wirelessly monitoring tire conditions on the vehicle. In the working mode, calibrated sensor data are generated at the sensor assembly from raw sensed data and using the calibration coefficients stored at the sensor assembly.

A system for wirelessly monitoring tire conditions on a vehicle comprises a plurality of sensor assemblies mounted on the vehicle. Each sensor assembly comprises at least one sensor for sensing a tire condition and generating associated sensor data, and a transceiver for communication of the sensor data. The system further comprises at least one communication module mounted on the vehicle for two-way communication between the sensor assemblies and at least one remote monitoring station. Each communication module comprises at least one transceiver and at least one antenna for communication with the sensor assemblies; a radio frequency (RF) modem for wireless communication with the at least one remote monitoring station, each remote monitoring station providing an RF coverage zone; and non-volatile memory for storing sensor data received from the sensor assemblies. A display unit is mounted on the vehicle and is configured to receive signals from the at least one communication module and relay the signals so that an operator can monitor tire conditions in real time. The communication module is configured to store sensor data received from the sensor assemblies in the non-volatile memory while the vehicle is not within any of the RF coverage zones. The communication module is also configured to transmit real-time sensor data from the sensor assemblies and stored sensor data from the non-volatile memory via the RF modem to a remote monitoring station when the vehicle is within the RF coverage zone of that remote monitoring station. For example, the stored sensor data transmitted from the non-volatile memory can be sensor data generated while the vehicle was not within any of the RF coverage zones. Optionally, the communication module is configured to also store sensor data received from the sensor assemblies in the non-volatile memory while the vehicle is within an the RF coverage zone.

In some embodiments, the system actually comprises at least one remote monitoring station. In some embodiments, the system further comprises at least one repeater for relaying sensor data to the at least one remote monitoring station, and the communication module is configured to transmit real-time sensor data from the sensor assemblies and stored sensor data from the non-volatile memory via the RF modem to the at least one remote monitoring station via the at least one repeater.

In some embodiments of the system, the communication module comprises one transceiver per antenna, for communication with the sensor assemblies.

In some embodiments of the system, the communication module further comprises an RS-232 driver, an Ethernet driver, a CAN driver, and/or a Wi-Fi driver for offloading sensor data stored in the non-volatile memory.

In some embodiments of the system, each sensor assembly further comprises a processor configured to modify sensor data based on calibration parameters stored at the sensor assembly.

In some embodiments of the system, each sensor assembly further comprises an activation mechanism that initiates operation of the sensor assembly in response to at least one of a signal from the communication module, a magnetic switch, or movement of the vehicle.

In some embodiments of the above-described method and system for wirelessly monitoring tire conditions on a vehicle, the tire condition is tire pressure and/or tire temperature.

### BRIEF DESCRIPTION OF DRAWINGS

FIG. 1 is a block diagram of an embodiment of a wireless monitoring system.

FIG. 1A is a block diagram of an embodiment of a portion of a wireless monitoring system.

FIG. 1B is a block diagram of an embodiment of a multi-zone wireless monitoring system.

FIG. 2 is a block diagram of an embodiment of a communication module.

FIG. 3 is a block diagram of an embodiment of a display unit (also known as a dashboard indicator assembly).

FIG. 4 is a block diagram of an embodiment of a tire sensor assembly.

FIG. 5 shows an example sequence (method) of operations for the tire status indicator when an irregular condition is detected at a sensor assembly.

FIG. 6 shows an example method for managing intermittent contact of monitoring systems on a vehicle with a remote monitoring station.

FIG. 7 shows an example method for configuring a sensor assembly remotely.

FIG. 8 illustrates a method for cycling a sensor assembly through different modes.

### DETAILED DESCRIPTION OF EMBODIMENTS OF THE INVENTION

The present invention relates to a wireless monitoring system and method that can be used to provide real-time monitoring of tire status while a vehicle is in use. The system and method can accommodate the vehicle going in and out of wireless coverage. Real-time sensor data on tire status is logged on the vehicle and transmitted to a remote monitoring station in real-time when the vehicle is within wireless coverage. When the vehicle goes out of wireless coverage, the real-time sensor data continues to be logged on the vehicle and is wirelessly transmitted to the remote monitoring station once the vehicle returns to wireless coverage. Wireless coverage can be provided in a number of zones around the remote monitoring station using one or more optional wireless repeaters.

The system provides diagnostic and monitoring information to the driver of the vehicle by means of a display unit that can provide visual and/or audible signals. The display unit is designed not to distract the driver unduly, and can provide an audible alert, for example, when there is an alarm condition requiring the driver to stop the vehicle. A diagnostic capability allows the driver to identify the location and nature of an irregular condition at one of the sensors e.g. an overheated tire.

In some embodiments, the sensor configuration and operational parameters are programmable. The communication module on the vehicle provides multiple data transfer and offloading options, both wired and wireless. In some embodiments, the module is designed as a network within a network, with one transceiver per antenna to improve sensitivity and each antenna able to communicate wirelessly with one or more sensor assemblies. In this configuration, each transceiver is dedicated to a particular antenna. Sensor assemblies can be calibrated during manufacture to achieve higher accuracy.

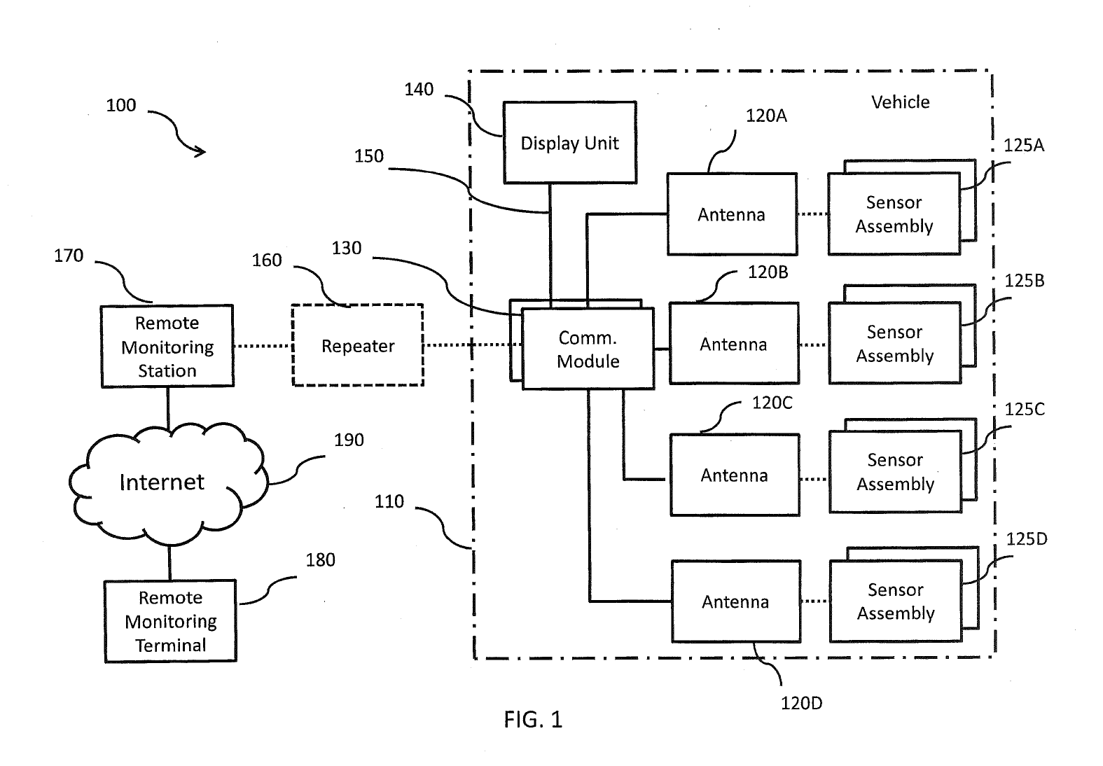

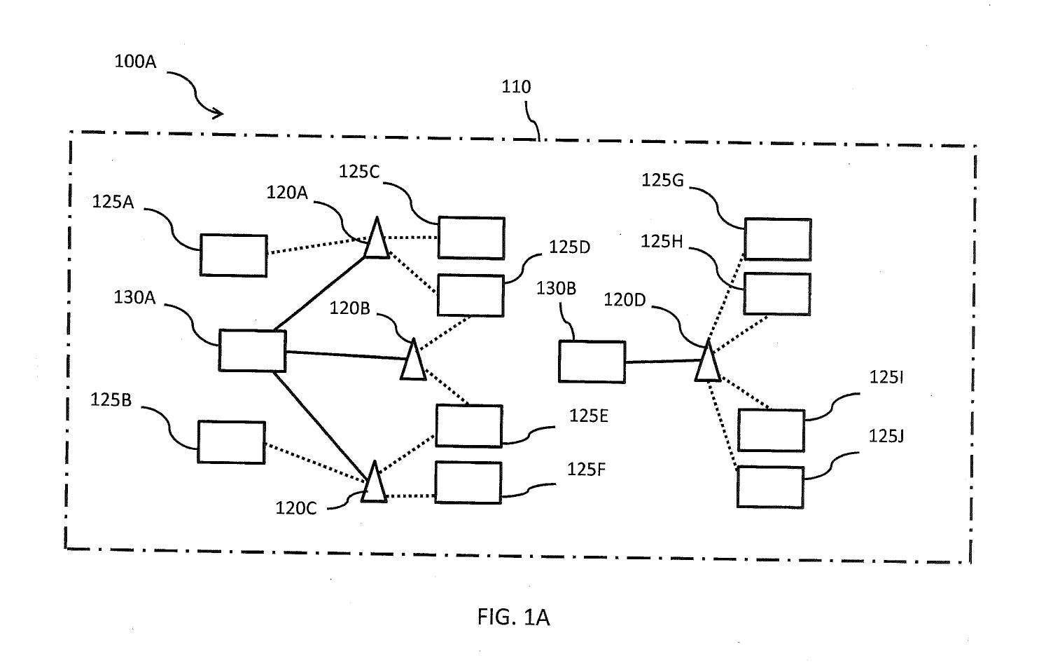

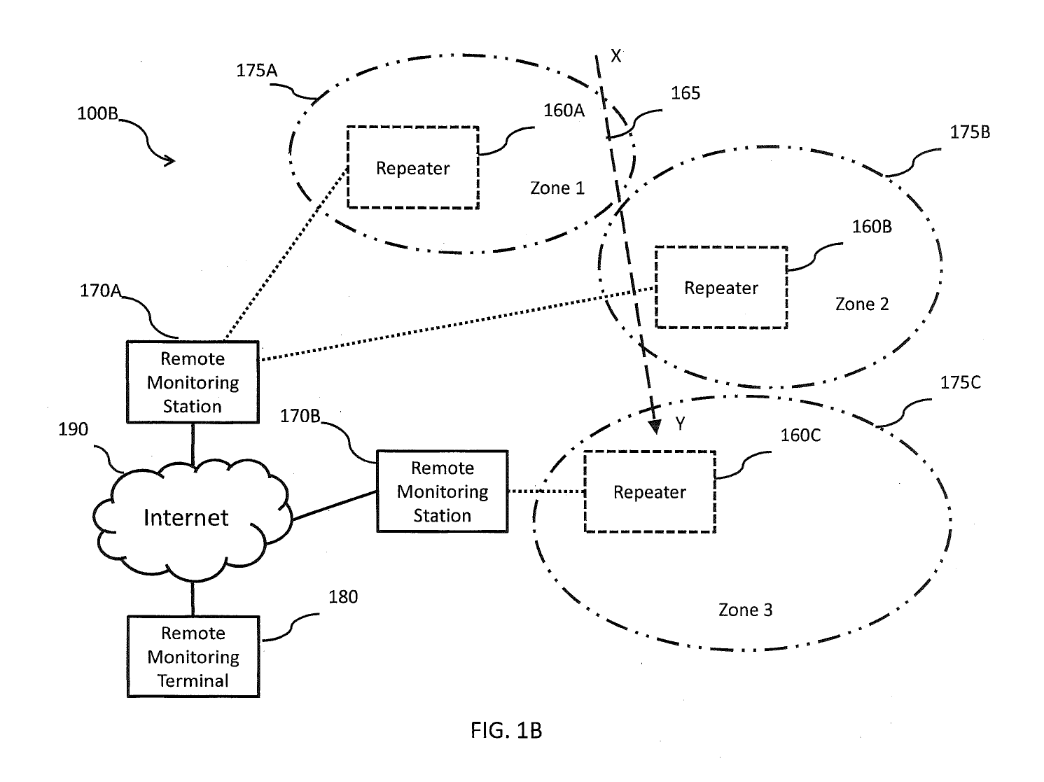

FIG. 1 is a block diagram of an embodiment of a wireless monitoring system 100. Embodiments of the system can be used to provide real-time monitoring of tire status on a vehicle 110 while the vehicle 110 is in use. Tire status can be monitored and logged whether or not the vehicle is within wireless range of a remote monitoring station or repeater. Sensed data for monitoring can be provided at predetermined intervals.

The status of each tire can be measured by sensors on a sensor assembly. FIG. 1 shows an example comprising four sensor assemblies 125A through 125D such as can be used for a vehicle with four tires. The sensor assemblies communicate wirelessly with antennas 120A through 120D (as indicated by the dotted lines) and antennas 120A through 120D are connected to a communication module 130 mounted on vehicle 110. Communication module 130 may sometimes be referred to as a master communication module.

FIG. 1 shows an example comprising four antennas 120A through 120D. The number and location of antennas depend on the vehicle and the distribution of sensor assemblies. In some embodiments, one sensor assembly can communicate wirelessly with more than one antenna. In other embodiments, more than one sensor assembly can communicate wirelessly with just one antenna. It is desirable for antennas to be positioned to reduce the number of blind spots in wireless coverage and to increase the reliability of wireless communication between antenna (e.g. 120A through 120D) and sensor assemblies (e.g. 125A through 125D).

As indicated in FIG. 1, there can be one or more communication modules 130 per vehicle 110. Each communication module 130 can be connected to one or more antennas (e.g. 120A through 120D), and each antenna can communicate wirelessly with one or more sensor assemblies (e.g. 125A through 125D).

In an example embodiment shown in FIG. 1A, a portion 100A of a wireless tire status monitoring system 100 from FIG. 1 comprises two communication modules 130A and 130B, one for the front section of the vehicle 110 and one for the rear. The front module 130A is connected to three antennas 120A through 120C. These in turn are able to communicate with sensor assemblies 125A through 125F in the front of the vehicle, for example in the tires of the front and middle axles.

The communication between antennas 120A-C and sensor assemblies 125A-F is wireless (as indicated by the dotted lines in FIG. 1A). Depending on the location of the elements and the surrounding environment, antennas 120A-C may be able to communicate with some or all of the sensor assemblies 125A-F. The antennas 120A-C are positioned to increase wireless coverage of sensor assemblies 125A-F and reduce the possibility of “blind spots” in the wireless coverage affecting communication between sensor assemblies 125A-F and module 130A via antennas 120A-C.

The rear communication module 130B is connected to a single antenna 120D which is in turn able to communicate wirelessly with four sensor assemblies 125G-J. As with the front module 130A, the antenna 120D is located to provide wireless coverage of the four sensor assemblies 125G-J taking into account possible blind spots.

FIG. 1A shows an example comprising four antennas 120A-D with three positioned toward the front of the vehicle and one positioned toward the rear. Other embodiments may have a different number of antennas positioned similarly or differently. It is generally beneficial to position antennas according to the desire to provide wireless coverage to the sensor assemblies.

Referring to FIG. 1, the communication module 130 can communicate wirelessly with a remote monitoring station 170 via an optional repeater or repeaters 160.

Data from sensor assemblies (e.g. 125A through 125D) can be transmitted over a wireless data channel to the remote monitoring station 170 for the purpose of monitoring real-time tire status such as temperature and pressure while vehicle 110 is within RF coverage of the remote monitoring station 170. In some embodiments, data can be transmitted over a wireless connection to a remote or remote monitoring station 170 via an optional repeater when vehicle 110 is out of range of remote monitoring station 170. When vehicle 110 is out of range of remote monitoring station 170 and repeater 160, data from sensor assemblies (e.g. 125A through 125D) are logged at the communication module 130, and offloaded to remote monitoring station 170 when the vehicle is once again within range. In some embodiments, data from sensor assemblies can continue to be transmitted when vehicle 110 is out of range of remote monitoring station 170 or repeater 160 even though the data is not being received by remote monitoring station 170 or repeater 160.

Signals can be transmitted to a display unit 140 via a power line 150 in vehicle 110, regardless of whether vehicle 110 is within RF coverage of remote monitoring station 170. Signals transmitted to display unit 140 can comprise alert, status and identification information intended for diagnosis and monitoring by the driver.

The remote monitoring station 170 can communicate with a remote monitoring terminal 180 via a network 190 (such as the Internet).

FIG. 1B is a block diagram of an embodiment of a multi-zone wireless monitoring system 100B. System 110B comprises the same elements as system 100 from FIG. 1. Vehicle 110 and elements of the system on-board the vehicle including sensor assemblies (e.g. 125A through 125D), communication module 130 and display unit 140 are not shown in FIG. 1B.

The embodiment shown in FIG. 1B is a system 110B comprising more than one repeater. The example in FIG. 1B comprises three repeaters 160A, 160B and 160C. Each repeater is associated with an RF coverage zone. Vehicles in operation can traverse a zone and move from one zone to another. Data transmitted by the communication module 130 from FIG. 1 in vehicle 110 can be relayed to a remote monitoring station 170 via a repeater (160A, 160B or 160C) in whose zone the vehicle is presently located. For example, in FIG. 1B vehicle 110 from FIG. 1 starts its route at point X. When it enters a first zone 175A, logged and real-time sensor data are transferred from the communication module 130 to remote monitoring station 170A via repeater 160A. When the vehicle leaves first zone 175A and enters a second zone 175B, data is transmitted to remote monitoring system 170A via repeater 160B. When the vehicle enters a third zone 175C en route to point Y, data are transferred to remote monitoring system 1706 via repeater 160C.

Data can be transferred from remote monitoring stations 170A and 1706 to a remote monitoring terminal 180 via a network 190 such as the Internet. This allows an operator connected to network 190 to monitor tire status information in real-time and to view stored data offloaded from the communication module 130 from FIG. 1 which was previously generated along the path X-Y of the vehicle.

Data can be transferred between remote monitoring stations 170A and 1706 via a network 190 such as the Internet.

RF coverage zones are provided by remote monitoring stations 170A and 170B, and by repeaters 160A, 160B and 160C. Other embodiments may have different numbers and configurations of remote monitoring stations and repeaters.

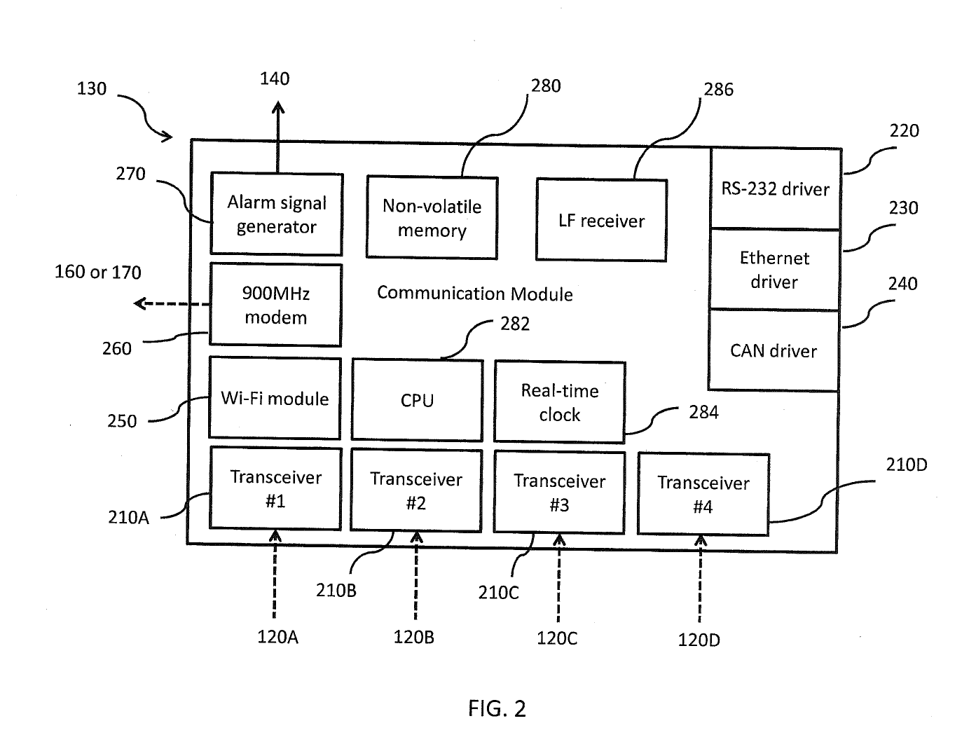

FIG. 2 is a block diagram of an embodiment of a communication module 130 from FIG. 1. FIG. 2 shows the connections of the communication module 130 to other elements of the wireless monitoring system shown in FIG. 1. The communication module 130 is located on the vehicle and monitors multiple sensors. The module receives data from antennas 120A through 120D from FIG. 1 via radio frequency data channels. The module can communicate the data received from the sensors to other devices via multiple data communication channels. Data can be logged with a real-time stamp.

In the example embodiment illustrated in FIG. 2, the communication module 130 comprises four transceivers 210A through 210D, each transceiver configured to communicate with a corresponding antenna 120A through 120D which in turn is in wireless communication with one or more sensor assemblies (e.g. 125A through 125D from FIG. 1). Communication between the communication module 130 and the sensor assemblies 125A through 125D via antennas 120A through 120D is two-way communication, all transceiver elements capable of both transmission and reception.

When communication module 130 from FIG. 1 and FIG. 2 is within range of repeater 160 or remote monitoring station 170, data such as tire temperature and pressure information can be transferred or offloaded from the communication module 130 via 900 MHz RF modem 260 over a 900 MHz radio link to the remote monitoring station 170.

Communication module 130 provides a variety of options (in addition to RF modem 260) for data transfer or offloading of sensed tire status data and other real-time monitoring information. Module 130 comprises an RS-232 driver 220, an Ethernet driver 230, a CAN driver 240, and a Wi-Fi module 250, some or all of which can be used to offload data stored on module 130.

Alarm signal generator 270 can send signals to display unit 140 from FIG. 1. Communication module 130 can store (or log) real-time sensor data from sensor assemblies 120A through 120D whether or not the vehicle is in wireless communication with remote monitoring station 170 from FIG. 1. Data can be stored (or logged) in non-volatile memory 280. In one embodiment, the size of memory 280 is 3 Mbytes. The memory can be for example FeRAM.

During time periods when the vehicle is not within an RF coverage zone provided by one or more remote monitoring stations (such as remote monitoring station 170), the sensed data related to the tire condition is stored in non-volatile memory 280 in the communication module 130. When the vehicle moves into an RF coverage zone of a remote monitoring station (e.g. 170), real-time sensed data related to the tire condition and stored data from non-volatile memory 280 is wirelessly transmitted, via RF modem 260, to the remote monitoring station. For example, historical data related to the tire condition that was stored in non-volatile memory 280 when the vehicle was not within an RF coverage zone is transmitted to the remote monitoring station when the vehicle moves into an RF coverage zone. When the vehicle is within an RF coverage zone, real-time sensed data is wirelessly transmitted to the remote monitoring station, and is optionally also stored in non-volatile memory 280 in communication module 130.

When communication module 130 moves within range of repeater 160 or remote monitoring station 170, remote monitoring station 170 can send a command to communication module 130 to request the offloading of historical sensed data stored in non-volatile memory 280 via the RF modem to remote monitoring station 170.

Sensitivity of transceivers 210A through 210D is important to operation of communication module 130. Sensitivity of −70 dBm to −80 dBm is expected. Higher than expected sensitivity (for example −102 dBm) can be achieved in communication module 130 with suitable layout and grounding of the printed circuit board (PCB). The transceivers can be connected without using a splitter. This may be beneficial in increasing sensitivity by 6 dBm for example. Software can also be used to configure the transceivers for improved sensitivity.

Communication module 130 shown in FIG. 2 can comprise a central processing unit (CPU) 282 connected to other elements of communication module 130 as required. Communication module 130 can comprise a real-time clock 284. In some embodiments, real-time clock 284 can be powered by capacitors and may work for an extended period (e.g. several weeks) when communication module 130 is not connected to a power source (e.g. 7.5V to 30V) on vehicle 110 from FIG. 1. Real-time clock 284 provides a time stamp for the real-time and stored sensed data. Communication module 130 can comprise a LF receiver 286 for communication via low frequency signals.

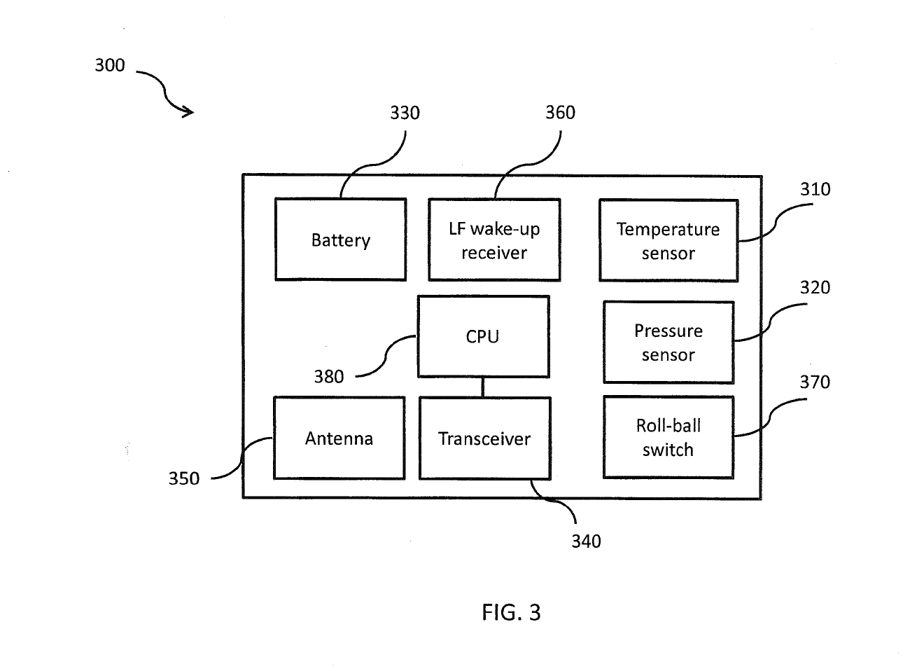

FIG. 3 is a block diagram of an embodiment of a sensor assembly 300 (e.g. 120A from FIG. 1). The sensor assembly 300 can comprise any suitable combination of sensors, for example a tire temperature sensor 310 and/or a pressure sensor 320. In preferred embodiments, the sensor assembly comprises a transceiver 340 and antenna 350 so that the device can receive information as well as transmit alarm, status and identification information to the communication module via a radio frequency data communication channel.

The transceiver 340 can be used during manufacturing of sensor assembly 300 for the purposes of calibration. The performance of sensor assembly 300 can be measured and coefficients calculated and downloaded to sensor assembly 300 by a calibration control unit (not shown). The accuracy of the system is increased by providing calibrated coefficients to each sensor assembly 300.

Power is provided to sensor assembly 300 by battery 330 or another suitable energy storage device.

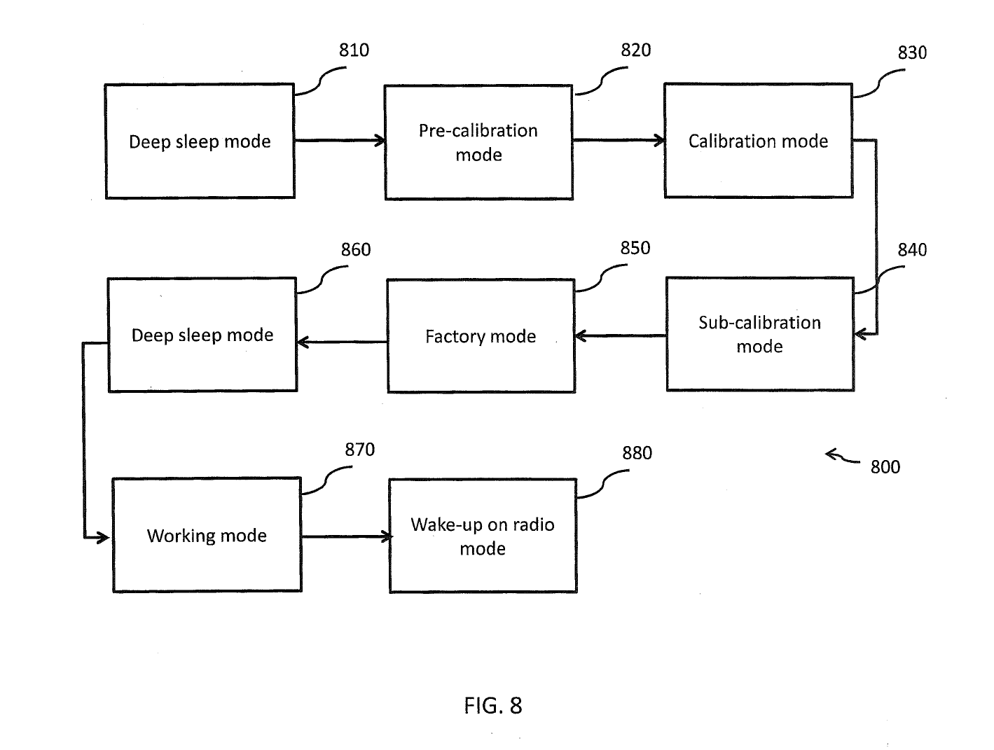

Sensor assembly 300 can comprise a low frequency (LF) wake-up receiver 360 used to activate sensor assembly and/or to cause sensor assembly 300 to transition between different modes of operation (see FIG. 8 and its accompanying description). The LF receiver cannot transmit data. In a preferred embodiment, the frequency on which activation or mode transition commands are received by LF receiver 360 is 125 kHz. In some embodiments, LF receiver 360 may be replaced by a different activation mechanism such as a magnetic switch (not shown).

In one embodiment, sensor assembly 300 can comprise a roll-ball switch 370 used to detect motion of sensor assembly 300 as a result of motion of vehicle 110 from FIG. 1, and activate sensor assembly 300. In some embodiments, sensor assembly 300 may stop transmitting if it detects via roll-ball switch 370 that vehicle 110 is no longer in motion for a certain time period. This may be beneficial in saving battery power and extending battery life. However, in some instances it may be desirable for a remote monitoring station to be able monitor a tire condition even while the vehicle is parked.

Sensor assembly 300 can comprise central processing unit (CPU) 380 connected to other elements such as transceiver 340. In some embodiments, CPU 380 may comprise a processor configured to modify sensor data based on calibration parameters stored at the sensor assembly.

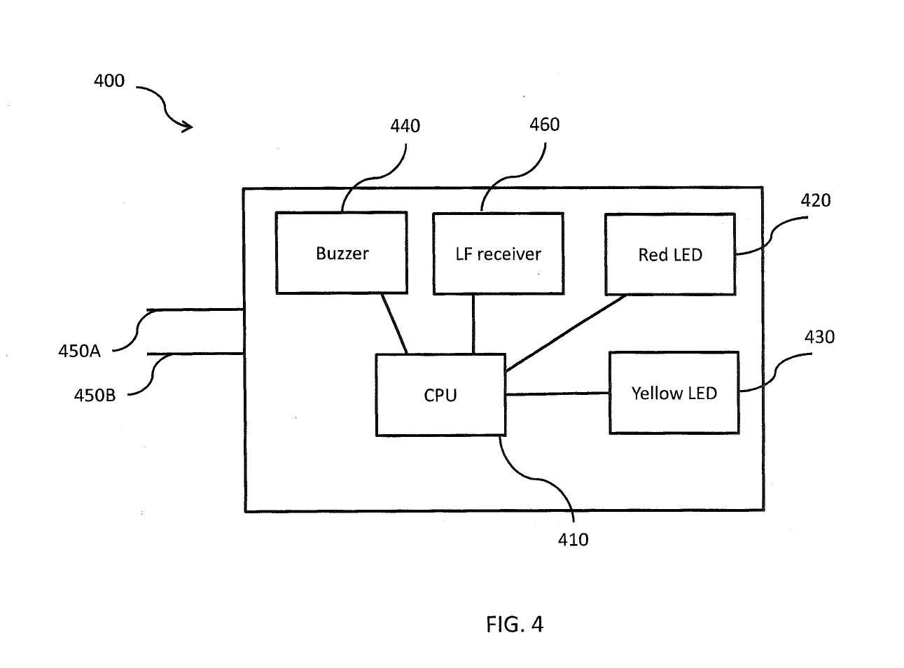

FIG. 4 shows the display unit 400 (140 from FIG. 1). The display unit 400 is sometimes known as the dashboard indicator assembly. The assembly 400 connects through the wiring harness of the vehicle 110 from FIG. 1 via two wires. The illustrated assembly comprises a CPU 410, two Light Emitting Diodes (LEDs) 420 and 430, a buzzer 440, two wires 450A and 450B, and LF receiver 460, all inserted into a dashboard indicator housing (not shown). The housing is installed in the dashboard of the vehicle. The two LEDs 420 and 430 can be used to signal alerts to the driver, and to provide status information and to identify the source and nature of alerts. The buzzer 440 can be used to generate an audible alert or signal to the driver. LF receiver 460 can receive modulated LF signals from communication module 130 from FIG. 1 via power line 450A and 450B. In one embodiment, the frequency of the LF communication can be 125 kHz.

Communication via power line 450A and 450B can comprise transmitting data packets according to a suitable protocol. For example, data packets may comprise a preamble, a pattern and data. In one embodiment, data packets may comprise an alarm data byte itself comprising eight bits—one each to indicate whether an alarm is pressure or temperature, and three bits each to indicate an alarm tire axle and an alarm tire position on the alarm tire axle. Any suitable alternative protocol and encoding of the data may be used.

The tire status indicator on the dashboard of the vehicle can provide information to the driver whether or not the vehicle is in contact with the remote monitoring station. The tire status indicator can alert the driver to the occurrence of an irregular condition in one or more of the sensor assemblies, provide status information on the condition (such as the nature of the condition e.g. an irregular temperature or pressure) of the sensor assemblies (e.g. 120A through 120D from FIG. 1, and provide more detailed information such as the identity and/or location of a sensor assembly with an irregular condition.

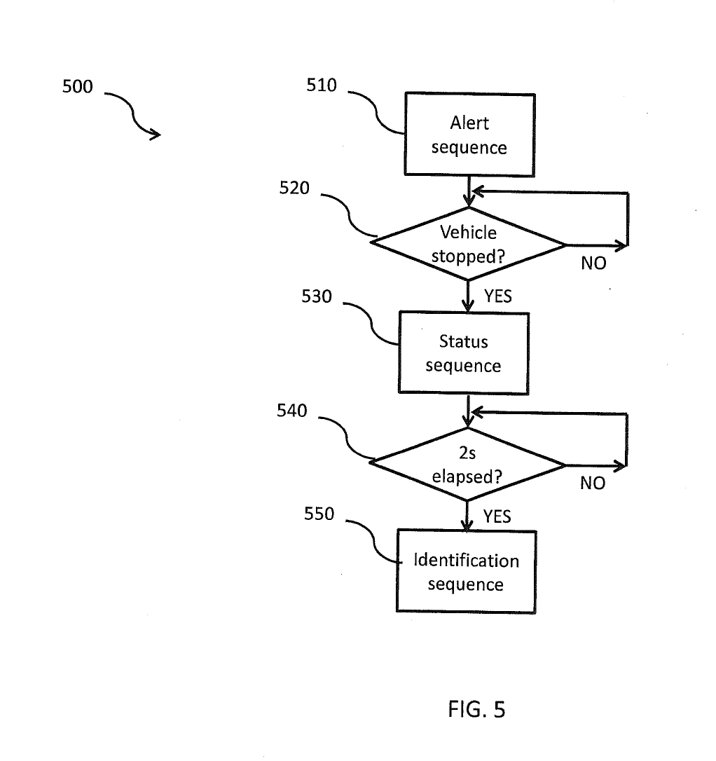

FIG. 5 shows an example sequence (or method) 500 of operations for the tire status indicator once an irregular condition at one or more of the sensor assemblies has occurred. When an irregular condition occurs, the tire status indicator enters an alert sequence 510 signalling the occurrence of an irregular condition at the sensor assembly. An alert may also be referred to as an alarm. An irregular condition may for example be an irregular temperature condition or an irregular pressure condition. For example, if the temperature at a sensor assembly exceeds a threshold then an alert can be sent to the display unit to indicate an overheated tire. In some embodiments, alert thresholds can be maintained in the communication module 130 from FIG. 1. In other embodiments, alert thresholds can be maintained in the sensor assemblies.

Alerts can be signalled by the use of audible and/or visual indications. In one embodiment, the dashboard indicator comprises a red LED and a yellow LED. The yellow LED may also be referred to as an orange light. The red LED can be used to show temperature alerts, and the yellow LED can be used to show pressure alerts. Various sequences can be used to alert the driver and indicate the nature of the irregular condition. For example, a sequence can be used in which the red and orange lights flash three times each in an alternating pattern. The sequence of flashes can be accompanied by an audible alert such as for example the sound of three beeps. After the initial alert sequence, the dashboard indicator can be used to indicate the nature of the irregular condition. For example, in one embodiment the red light can remain ON if an irregular temperature condition exists. Similarly, the orange light can remain ON if an irregular pressure condition exists. If both temperature and pressure irregularities exist, then both the red and orange lights can remain ON. In some embodiments, the indicator lights can remain ON until the irregular condition ceases to be present, at which time the corresponding indicator light(s) can turn off.

In the example embodiment illustrated in FIG. 5, the driver can stop the vehicle after receiving an alert and subsequently initiate a status sequence. Once the driver has been alerted to the irregular condition, the method proceeds to step 520 and waits until the vehicle has stopped (YES). At step 530, the driver initiates a status sequence for example by turning the key to the OFF position and then turning the key to the accessory ON position.

In one embodiment of the status sequence, the tire status indicator can show status information indicating whether the irregular condition currently exists or has ceased to exist. If the irregular condition still exists, then the alert sequence can be repeated. For example, the red and orange lights can flash three times each in an alternating pattern or any other suitable pattern. The flashing can be accompanied by an audible alert such as three audible beeps. After the alert sequence has been repeated, the red light can remain ON if an irregular temperature condition exists, and the orange light can remain ON if an irregular pressure condition exists. If both temperature and pressure irregularities exist, then both red and oranges lights can remain ON.

In one embodiment, if the irregular condition ceases to exist, the red and orange lights can flash together three times. The flashing can be accompanied by an audible alert such as three beeps.

Once the status sequence completes, the method proceeds to step 540 where the tire status indicator waits a predetermined period of time (e.g. 2 s) before proceeding to the identification sequence 550. The identification sequence indicates in which sensor assembly the irregular condition exists. In the case where the irregular condition has ceased to exist, the identification sequence indicates the sensor assembly with the most recently reported irregular condition. In the identification sequence, more detailed information such as the identification and/or location of the sensor assembly can be provided by means of a visual indication on the tire status indicator.

Any suitable pattern can be used to identify the sensor assembly. In one embodiment, each axle position can be allocated a number from 1 through to the total number of axles on the vehicle in a sequence known to the operator (e.g. front to back). The red light can indicate the axle position of the sensor assembly by flashing a number of times equal to the number of the axle comprising the sensor assembly with the irregular condition (or the most recently reported irregular condition). Each tire position can be allocated a number from 1 through to the total number of tires per axle in a sequence known to the operator (e.g. driver side to passenger side). The orange light can indicate the tire position of the sensor assembly by flashing a number of times equal to the number of the tire comprising the sensor assembly with the irregular condition (or the most recently reported irregular condition).

At the end of the identification sequence 550, the red light can remain ON if an irregular temperature condition continues to exist and/or the orange light can remain ON if an irregular pressure condition continues to exist. If an irregular condition ceases to be present (or is corrected), the corresponding light can turn OFF.

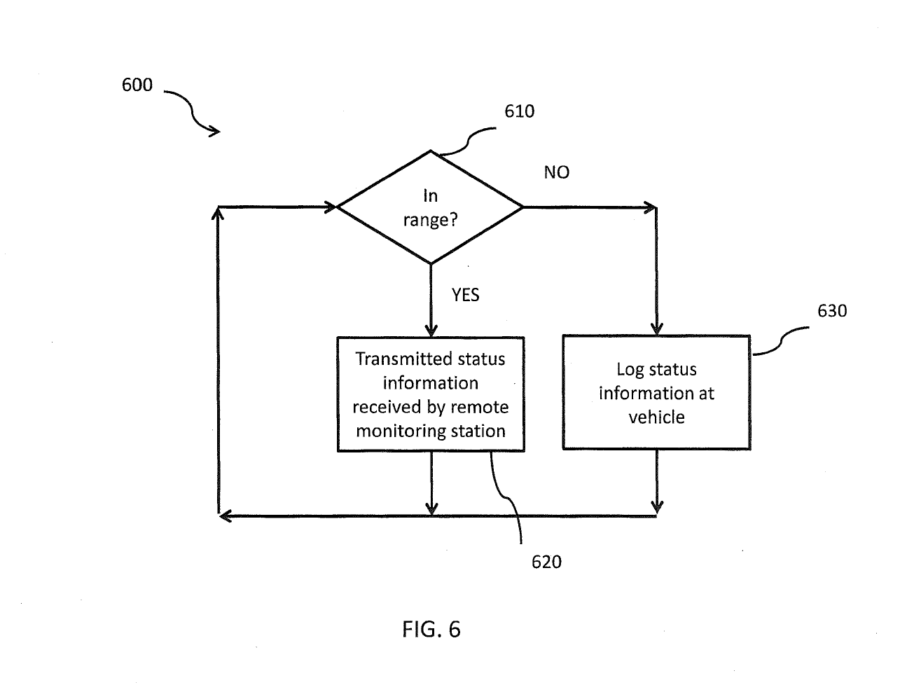

FIG. 6 shows an example method 600 for managing intermittent contact of monitoring systems on a vehicle with a remote monitoring station. The system checks at step 610 to determine whether the vehicle is within range of the remote monitoring station or within range of one of the repeaters. If the vehicle is within range (YES), then the method proceeds to step 620 and the system transmits status information from the communication module on the vehicle to the repeater or the remote monitoring station. During this time, the communication module can send alerts, status and identification information to the display unit 140 on the vehicle.

If the vehicle goes out of range of the remote monitoring station or one of the repeaters (NO), then the method proceeds to step 630 and the system continues to monitor the tire status in real-time and logs the information on-board the vehicle in the communication module. During this time, the communication module can send alerts, status and identification information to the display unit. When the vehicle restores wireless contact with the remote monitoring station or the repeater, the communication module transmits the stored data to the remote monitoring station.

Referring to FIG. 1, in some embodiments, communication module 130 can continue to transmit data even when out of range of repeater 160 or remote monitoring station 170. During this time, real-time sensor data is stored at communication module and offloaded upon command from remote monitoring station 170 when within range once again.

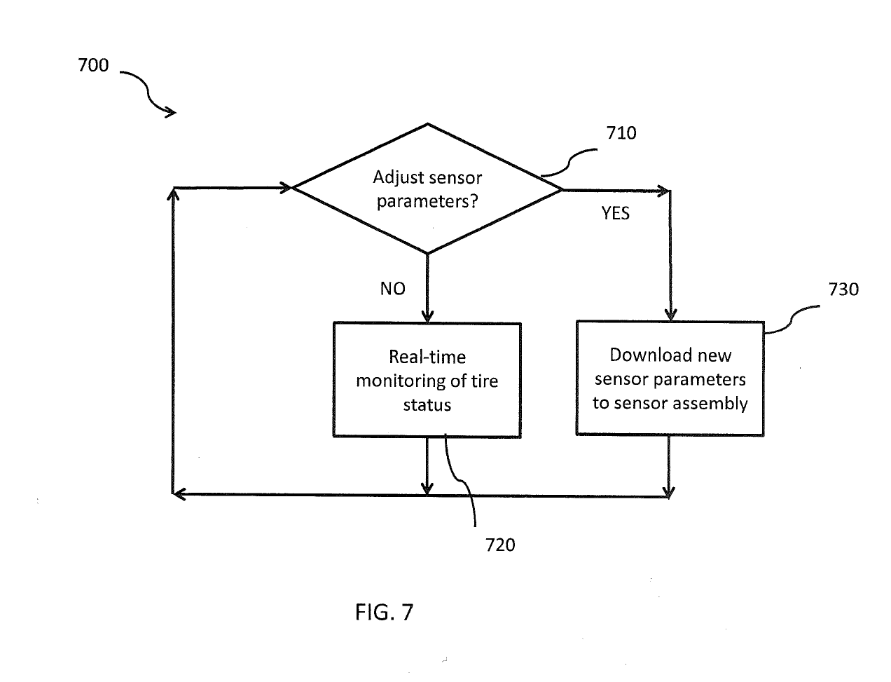

FIG. 7 shows an example method 700 for configuring a sensor assembly (e.g. 125A from FIG. 1) remotely. Method 700 utilizes the two-way communication capability of the wireless monitoring system described herein. Step 710 determines whether the sensor assembly needs to be configured and the sensor parameters adjusted. Examples of sensor parameters include reporting interval and sensor threshold (e.g. high temperature or low pressure). If the sensor assembly does not require configuration, then the method proceeds to step 720 where the system 100 from FIG. 1 provides real-time monitoring of tire status. If the sensor assembly requires configuration and the sensor parameters need adjusting, then the method 700 proceeds to step 730 where new sensor parameters are downloaded from the remote monitoring station 170 from FIG. 1, or the communication module 130 from FIG. 1, to the sensor assembly. In the case of multiple sensor assemblies (e.g. 125A through 125D from FIG. 1), separate sets of parameters can be downloaded to each sensor assembly 125A, 125B, 125C or 125D.

In some embodiments, LF activation may be required to change mode so that the sensor assembly is ready to accept new sensor parameters.

FIG. 8 illustrates a method 800 for cycling a sensor assembly through different modes. A sensor assembly (e.g. 125A from FIG. 1) enters deep sleep mode 810 when it is manufactured. In mode 810, the sensor assembly draws very little current (e.g. <10 μA) and thereby preserves battery life. In this mode, the sensor assembly is safe for shipping. When activated, the sensor assembly proceeds to pre-calibration mode 820. Activation can be performed using a magnetic switch and RF command, or via low frequency transmission to a receiver on the sensor assembly.

In calibration mode 830, the sensor assembly transmits data to a receiver for test purposes using any suitable packet format. From this data, coefficients can be calculated that can be used to compute one or more calibrated sensor outputs, e.g. calibrated temperature and/or calibrated pressure. Since temperature and pressure depend on one another, at least four measurement points are necessary to define the coefficients for calibration. These four points may for example be −30° C. at 0 psi, −30° C. at 150 psi, +80° C. at 0 psi and +80° C. at 150 psi. The data is fitted to a curve and the coefficients of the fit are downloaded to the sensor assembly after calibration is complete. Calibration requires the sensor assembly to be producing stable output in a stable pressure and temperature environment at the desired pressure and temperature values. Calibration is performed, and separate coefficients are calculated, for each sensor assembly entering calibration mode 830.

In some embodiments, calibration may increase accuracy of pressure readings from say ±7 psi (with no calibration) to ±1 psi (with calibration). Accuracy of temperature output may increase from say ±10° C. to ±1° C.

After coefficients have been downloaded to the sensor assembly, the sensor assembly proceeds to sub-calibration mode 840 in which the coefficients are verified by means of testing. The calibration sequence then proceeds to factory mode 850 which is the same as working mode 870 except that no RF activation is required. Mode 850 is for the purposes of testing. When the sensor assembly is ready to ship from the factory, the sequence proceeds to deep sleep mode 860. Before installation, for example in vehicle 110 from FIG. 1, the sensor assembly is activated by an RF command and enters working mode 870. In some cases, it may be beneficial to activate the sensor assembly after installation.

While in working mode 870, the sensor assembly checks the sensor output (e.g. tire pressure and temperature) and transmits it to the communication module with any suitable ancillary data (such as state data) at a predetermined reporting interval. While in working mode 870, calibrated sensor data are generated at the sensor assembly from raw sensed data and using the calibration coefficients stored at the sensor assembly. The raw sensed data are the data received from the sensor before calibration.

When the sensor assembly has spent a pre-determined period of time below a pressure threshold (for example 5 psi), such as might occur if it is removed from the tire, the sensor assembly enters wake-up on radio mode 880. Upon entry to mode 880, the sensor assembly stops transmitting and waits for either a wake-up command, operation of a magnet switch, activation via an LF signal, or the pressure to rise above a threshold (e.g. 10 psi). Mode 880 may be beneficial for example in the case the sensor assembly is removed from a vehicle and may be necessary for FCC approval.

FIG. 8 illustrates an example sequence of transitions between modes. In other sequences, the sensor assembly can move between modes in a different order. The sensor assembly need not traverse all modes in any particular sequence.

In some embodiments, the sensor assembly can be activated or caused to transition between modes by means of roll-ball switch 370 from FIG. 3.

Where a component is referred to above, unless otherwise indicated, reference to that component should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example, features from any of the embodiments described herein may be combined with features of other embodiments described herein to provide further embodiments.

1-28. (canceled)

29. A method for wirelessly monitoring tire conditions on a vehicle, the method comprising:
a) sensing a tire condition using at least one sensor assembly;
b) wirelessly transmitting sensed data related to the tire condition to a communication module mounted on the vehicle;
c) sending a signal from the communication module to a display unit mounted on the vehicle so that an operator can monitor tire conditions in real time;
d) during time periods when the vehicle is not within an RF coverage zone provided by one or more remote monitoring stations, storing sensed data related to the tire condition in non-volatile memory in the communication module; and
e) when the vehicle moves into the RF coverage zone of at least one of the remote monitoring stations, wirelessly transmitting real-time sensed data related to the tire condition, and stored data from the non-volatile memory, via an RF modem to at least one of the remote monitoring stations.

30. The method of claim 29, wherein the RF modem in the communication module transmits the real-time and stored sensed data to at least one repeater located within RF coverage of the vehicle, wherein the at least one repeater relays the transmitted data to at least one of the remote monitoring stations.

31. The method of claim 29, wherein there is two-way communication between the one or more remote monitoring stations and the sensor assemblies via the communication module when the vehicle is within an RF coverage zone provided by the one or more remote monitoring stations.

32. The method of claim 29, wherein the tire condition is at least one of a pressure and a temperature.

33. The method of claim 29, wherein the method further comprises wirelessly transmitting the sensed data from the at least one sensor assembly to the communication module via at least one antenna mounted on the vehicle which is connected to at least one transceiver in the communication module.

34. The method of claim 33, wherein each of the at least one antennas is connected to a dedicated transceiver in the communication module.

35. The method of claim 29, wherein the real-time sensed data continues to be transmitted by the communication module via the RF modem even when the vehicle is not within any of the RF coverage zones provided by the one or more remote monitoring stations.

36. The method of claim 29, further comprising from time to time offloading the sensed data stored in the non-volatile memory via at least one of an RS-232 driver, an Ethernet driver, a CAN driver, and a Wi-Fi driver in the communication module.

37. The method of claim 31, further comprising transmitting parameters to the sensor assemblies from the at least one remote monitoring station, via the communication module and a transceiver in the sensor assembly, for calibration of sensors in the at least one sensor assembly.

38. The method of claim 29, wherein each sensor assembly is first activated prior to the sensing of tire conditions by receiving a signal from the communication module, a magnetic switch or by movement of the at least one sensor assembly.

39. The method of claim 29, comprising updating parameters in each sensor assembly during operation of the vehicle, the parameters received from either the communication module or the at least one remote monitoring station.

40. A system for wirelessly monitoring tire conditions on a vehicle, the system comprising:
a plurality of sensor assemblies mounted on the vehicle, each sensor assembly comprising:
at least one sensor for sensing a tire condition and generating associated sensor data; and
a transceiver for communication of the sensor data;
a communication module mounted on the vehicle for two-way communication between the sensor assemblies and at least one remote monitoring station, each communication module comprising:
at least one transceiver and at least one antenna for communication with the sensor assemblies;
a radio frequency (RF) modem for wireless communication with the at least one remote monitoring station each station providing an RF coverage zone to the vehicle; and
non-volatile memory for storing sensor data received from the sensor assemblies:
a display unit mounted on the vehicle configured to receive signals from the at least one communication module and relay the signals so that an operator can monitor tire conditions in real time;
wherein the communication module is configured to:
store sensor data received from the sensor assemblies in the non-volatile memory while the vehicle is not within any of the RF coverage zones; and
transmit real-time sensor data from the sensor assemblies and stored sensor data from the non-volatile memory via the RF modem to a remote monitoring station when the vehicle is within the RF coverage zone of that remote monitoring station, wherein the stored sensor data transmitted from the non-volatile memory is sensor data generated while the vehicle was not within any of the RF coverage zones.

41. The system of claim 40 wherein the system comprises a plurality of communication modules mounted on the vehicle for two-way communication between the sensor assemblies and the at least one remote monitoring station.

42. The system of claim 40 further comprising the at least one remote monitoring station and comprising at least one repeater for relaying sensor data to the at least one remote monitoring station wherein the communication module is configured to transmit real-time sensor data from the sensor assemblies and stored sensor data from the non-volatile memory via the RF modem to the at least one remote monitoring station via the at least one repeater.

43. The system of claim 40, wherein the communication module comprises one transceiver per antenna for communication with the sensor assemblies.

44. The system of claim 40, wherein the communication module further comprises at least one of an RS-232 driver, an Ethernet driver, a CAN driver, and a Wi-Fi driver for offloading sensor data stored in the non-volatile memory.

45. The system of claim 40, wherein each sensor assembly further comprises a processor configured to modify sensor data based on calibration parameters stored at least one of the sensor assemblies.

46. The system of claim 40 wherein the tire condition is at least one of a pressure and a temperature.

47. The system of claim 40 wherein the communication module is configured to transmit an operating parameter from the at least one remote monitoring station to at least one of the sensor assemblies, via the transceiver in the at least one of the sensor assemblies, for adjusting operation of the at least one sensor assembly while the vehicle is in operation.

48. The system of claim 47 wherein the operating parameter is one of a reporting interval, a calibration parameter and an alert threshold.
